(19) United States
(12) Patent Application Publication
(10) Pub. No.: US 2023/0256421 A1
(43) Pub. Date: Aug. 17, 2023

(54) CARBON MONOXIDE AND HYDROCARBON OXIDATION CATALYST, A METHOD FOR PREPARING SAME, AND AN OXIDATION METHOD FOR CARBON MONOXIDE AND HYDROCARBON USING SAME

(71) Applicants: HYUNDAI MOTOR COMPANY, Seoul (KR); Korea University Research and Business Foundation, Seoul (KR); KIA CORPORATION, Seoul (KR)

(72) Inventors: Kwan-Young Lee, Seoul (KR); Dalyoung Yoon, Seongnam-si (KR); Hyun Wook Jung, Seoul (KR); Haney Park, Seoul (KR); Eun Jun Lee, Seoul (KR); Hyoseong Woo, Seoul (KR)

(73) Assignees: HYUNDAI MOTOR COMPANY, Seoul (KR); KIA CORPORATION, Seoul (KR); Korea University Research and Business Foundation, Seoul (KR)

(21) Appl. No.: 17/968,490

(22) Filed: Oct. 18, 2022

(30) Foreign Application Priority Data
Feb. 15, 2022 (KR) 10-2022-0019705

(51) Int. Cl. B01J 23/75; B01J 23/10; B01J 23/72; B01J 35/00; B01J 37/03; B01J 37/02; B01J 37/08; B01J 37/10; B01D 53/94

(52) U.S. Cl. CPC B01J 23/75; B01J 23/10; B01J 23/72; B01J 35/0013; B01J 37/031; B01J 37/0221; B01J 37/0228; B01J 37/0242; B01J 37/0236; B01J 37/088; B01J 37/10; B01D 53/944; B01D 2255/20746; B01D 2255/2065; B01D 2255/20761

(57) ABSTRACT

Provided is a carbon monoxide and hydrocarbon oxidation catalyst that includes a core-shell nanoparticle including a cobalt (Co) nanoparticle core having a hexahedral shape, and a shell surrounding the cobalt nanoparticle core and including cerium oxide.

### CROSS-REFERENCE TO RELATED APPLICATION

This application claims priority to and the benefit of Korean Patent Application No. 10-2022-0019705, filed in the Korean Intellectual Property Office on Feb. 15, 2022, the entire contents of which are incorporated herein by reference.

### BACKGROUND

### (a) Field

The present disclosure relates to a catalyst used for the oxidation reaction of carbon monoxide and hydrocarbon, a method for preparing the same, and an oxidation method for carbon monoxide and hydrocarbon using same.

### (b) Description of the Related Art

The statements in this section merely provide background information related to the present disclosure and may not constitute prior art.

An exhaust gas of a gasoline vehicle is purified by a three-way catalyst. When a temperature of the catalyst is greater than or equal to 400° C., a purification performance may reach nearly 100%. However, in the cold-start section immediately after engine start, the three-way catalyst does not operate properly, so pollutants in the exhaust gas are discharged into the atmosphere. In particular, it is known that about 70% of pollutants is emitted in the cold-start section of hydrocarbon (HC).

In addition, we have found that because the catalyst is deactivated when exposed the exhaust gas at a high temperature while driving a vehicle, high heat resistance of the catalyst is desired.

### SUMMARY

The present disclosure provides a carbon monoxide and hydrocarbon oxidation catalyst having improved durability and excellent oxidation performance of carbon monoxide and hydrocarbon.

One aspect of the present disclosure provides a method for preparing the carbon monoxide and hydrocarbon oxidation catalyst.

Another aspect provides an oxidation method of carbon monoxide and hydrocarbon using the carbon monoxide and hydrocarbon oxidation catalyst.

According to one aspect, a carbon monoxide and hydrocarbon oxidation catalyst includes a core-shell nanoparticle including a cobalt (Co) nanoparticle core having a hexahedral shape, and a shell surrounding the cobalt nanoparticle core, wherein the shell includes cerium oxide.

The core-shell nanoparticle may include cobalt (Co) and cerium (Ce) in a mole ratio of greater than 1:0 to less than 1:15.4.

The catalyst may further include a metal supported on the core-shell nanoparticle.

The metal may include copper (Cu), iron (Fe), cobalt (Co), Titanium (Ti), Zinc (Zn), manganese (Mn), nickel (Ni), aluminum (Al), chromium (Cr), tungsten (W), silicon (Si), iridium (Ir), platinum (Pt), rhodium (Rh), palladium (Pd), ruthenium (Ru), Thorium (Th), Vanadium (V), gold (Au), silver (Ag), Rhenium (Re), Zirconium (Zr), molybdenum (Mo), or a mixture thereof.

The catalyst may include 1 percent by weight (wt. %) to 4 wt. % of the metal based on the total weight of the catalyst.

According to another aspect, a method for preparing a carbon monoxide and hydrocarbon oxidation catalyst includes: preparing a cobalt (Co) nanoparticle core having a hexahedral shape; and forming a shell surrounding the cobalt nanoparticle core, wherein the shell includes cerium oxide to prepare a core-shell nanoparticle.

The cobalt nanoparticle core may be prepared by dissolving a cobalt precursor and sodium hydroxide, potassium hydroxide, ammonia, or a mixture thereof in a solvent, followed by hydrothermal synthesis.

The sodium hydroxide may be mixed in a range from 2 parts by weight to 10 parts by weight based on 100 parts by weight of the cobalt precursor.

The hydrothermal synthesis may be performed at a temperature in a range of 120° to 250° for 3 hours to 8 hours.

The shell may be formed by dispersing the cobalt nanoparticle core in a solvent to obtain a dispersion, mixing a cerium precursor and an oxidizing agent in the dispersion, drying the cobalt nanoparticle core, and then firing.

The solvent may include 20 volume % to 80 volume % of water and 20 volume % to 80 volume % of ethanol based on the total volume of the solvent.

The oxidizing agent may include urea, ammonia, sodium carbonate, sodium bicarbonate, potassium carbonate, potassium bicarbonate, sodium acetate, potassium acetate, diethanol amine, trimethylamine, hexamethylene diamine, tetramethylammonium hydroxide, or a mixture thereof.

A metal may be supported on the core-shell nanoparticle.

The metal may be supported by dissolving a precursor of the metal in a solvent, impregnating the core-shell nanoparticle, drying the metal, and then firing.

The catalyst may be subjected to hydrothermal treatment.

The hydrothermal treatment may be performed at a temperature in a range of 600° C. to 900° C. for 10 hours to 100 hours.

The hydrothermal treatment may be performed in an air atmosphere including 0 volume % to 20 volume % of water (H₂O) and 5 volume % to 20 volume % of oxygen (O₂).

According to another aspect, an oxidation method of carbon monoxide and hydrocarbon includes reacting carbon monoxide, a hydrocarbon, or a mixture thereof with oxygen in the presence of the catalyst to perform oxidation.

The hydrocarbon may include propene, toluene, ethane, ethene, propane, benzene, xylene, ethylene, 2-methylbutane, formaldehyde, styrene, acetaldehyde, or a mixture thereof.

The carbon monoxide and hydrocarbon oxidation catalyst according to one aspect has improved durability and excellent oxidation performance of carbon monoxide and hydrocarbon.

### BRIEF DESCRIPTION OF THE DRAWINGS

In order that the disclosure may be well understood, there will now be described various forms thereof, given by way of example, reference being made to the accompanying drawings, in which:

FIG. 1 is a process flow chart showing a method for preparing a carbon monoxide and hydrocarbon oxidation catalyst according to one aspect of the present disclosure;

FIG. 2 is a transmission electron microscope (TEM) photograph of cobalt nanoparticles having a hexahedral shape prepared in Example 1;

FIG. 3 is an element mapping image of the catalyst prepared in Example 1;

FIG. 4 is a graph showing the measurement results of oxidation performance of carbon monoxide and hydrocarbon according to the shell content of catalysts prepared in examples and comparative examples; and

FIG. 5 is a graph showing the measurement results of oxidation performance of carbon monoxide and hydrocarbon according to the supported metal content of catalysts prepared in examples and comparative examples.

The drawings described herein are for illustration purposes only and are not intended to limit the scope of the present disclosure in any way.

### DETAILED DESCRIPTION

The advantages and features of the present disclosure and the methods for accomplishing the same should be apparent from the embodiments described hereinafter with reference to the accompanying drawings. However, an implemented form may not be limited to exemplary embodiments disclosed below. Unless otherwise defined, all terms (including technical and scientific terms) used herein have the same meaning as commonly understood by one of ordinary skill in the art. In addition, terms defined in a commonly used dictionary are not to be ideally or excessively interpreted unless explicitly defined.

In addition, unless explicitly described to the contrary, the word “comprise,” and variations such as “comprises” or “comprising,” should be understood to imply the inclusion of stated elements but not the exclusion of any other elements. When a component, device, element, or the like of the present disclosure is described as having a purpose or performing an operation, function, or the like, the component, device, or element should be considered herein as being “configured to” meet that purpose or to perform that operation or function.

Further, the singular includes the plural unless mentioned otherwise.

The carbon monoxide and hydrocarbon oxidation catalyst (hereinafter, referred to as “catalyst”) according to one aspect includes core-shell nanoparticles including a core and a shell surrounding the core.

The core contains cobalt nanoparticles.

The cobalt nanoparticles may have a controlled shape. For example, the cobalt nanoparticles may have a generally hexahedral shape. As an example, the cobalt nanoparticles having a generally hexahedral shape may have six main surfaces on the surface. In some embodiments, the area occupied by the six main surfaces may be greater than or equal to 50 area %, greater than or equal to 60 area %, greater than or equal to 70 area %, greater than or equal to 80 area %, or greater than or equal to 90 area % of the total surface of the cobalt nanoparticles. In addition, the cobalt nanoparticles may further include additional small surfaces between the six main surfaces.

When cobalt nanoparticles have a hexahedral shape, they exhibit high stability, and activity may be promoted by exposing a large amount of (001) planes.

The core of the cobalt nanoparticles may be included in a range from 4 wt. % to 100 wt. % for example, 4 wt % to 100 wt % based on the total weight of the catalyst. When the content of the core of the cobalt nanoparticles is less than 4 wt. %, cerium oxide is formed as a separate mass, and the catalytic activity may decrease due to the sintering phenomenon after hydrothermal treatment.

The shell surrounding the core includes cerium oxide.

For example, the shell including cerium oxide may have a film shape having a continuous and dense structure. A thickness of the shell may be in a range of 5 nm and 50 nm. If the thickness of the shell is less than 5 nm, it may be vulnerable to heat resistance. If the thickness of the shell exceeds 50 nm, gas diffusion may be difficult.

The core-shell nanoparticles may include cobalt (Co) and cerium (Ce) in a mole ratio of greater than 1:0 and less than 1:15.4, for example, in a range of 1:0 to 1:30. When the mole ratio of cobalt to cerium is 1:15.4 or more, cerium oxide is formed as a separate mass, and catalyst activity may decrease due to sintering phenomenon after hydrothermal treatment.

The core-shell nanoparticles may have an average size in a range of 50 nm to 400 nm. If the size of the core-shell nanoparticles is less than 50 nm, the core-shell nanoparticles may not be evenly dispersed, and if the size of the core-shell nanoparticles exceeds 400 nm, catalytic active sites may decrease and thus the activity may decrease.

The catalyst may further include a metal supported on the core-shell nanoparticles.

For example, the metal may include Cu, Fe, Co, Ti, Zn, Mn, Ni, Al, Cr, W, Si, Ir, Pt, Rh, Pd, Ru, Th, V, Au, Ag, Re, Zr, Mo, or a mixture thereof.

An average size of the metal may be in a range of 1 nm to 30 nm. If the average size of the metal is less than 1 nm, the activity of the catalyst may decrease, and if the average size of the metal exceeds 30 nm, activity of the catalyst may decrease due to a sintering phenomenon.

The metal may be included in a range from 1 wt. % to 4 wt. % based on the total weight of the catalyst. If the metal content is less than 1 wt. %, catalytic active sites may decrease and thus the activity of the catalyst may decrease, and if the metal content exceeds 4 wt. %, activity of the catalyst may decrease due to a sintering phenomenon.

According to another aspect of the present disclosure, the method for preparing a carbon monoxide and hydrocarbon oxidation catalyst includes preparing a cobalt (Co) nanoparticle core having a hexahedral shape, forming a shell surrounding the cobalt nanoparticle core and including cerium oxide, to prepare core-shell nanoparticles.

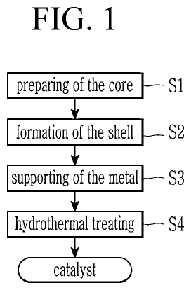

FIG. 1 is a process flow chart showing a method for preparing a carbon monoxide and hydrocarbon oxidation catalyst. Hereinafter, a method for preparing a carbon monoxide and hydrocarbon oxidation catalyst is described in detail with reference to FIG. 1.

The preparing of the cobalt nanoparticle core (Step S1) may be accomplished by dissolving a cobalt precursor and sodium hydroxide (NaOH) in a solvent and performing hydrothermal synthesis.

The cobalt precursor may include cobalt nitrates, cobalt hydrochlorides, cobalt acetates, cobalt sulfates, cobalt hydroxides, hydrates thereof, or a mixture thereof, for example cobalt (II) nitrate (Co(NO₃)₂), or hydrates thereof.

The solvent may include distilled water, deionized water, ethanol, methanol, ethylene glycol, propylene glycol, isopropyl alcohol, or a mixture thereof.

The sodium hydroxide may play a role in synthesizing cobalt nanoparticles having a hexahedral shape with a target size by adjusting pH. In addition to sodium hydroxide, potassium hydroxide, ammonia or a mixture thereof may be used.

The sodium hydroxide may be mixed in a range from 2 parts by weight to 10 parts by weight based on 100 parts by weight of the cobalt precursor. When the content of sodium hydroxide is less than 2 parts by weight, the hexahedral cobalt nanoparticles may not be sufficiently formed, and when it exceeds 10 parts by weight, the structure may collapse due to a strong base.

The hydrothermal synthesis may be performed at a temperature in a range of 120° C. to 250° C. for 3 hours to 8 hours. If the hydrothermal synthesis temperature is less than 120° C., hexahedral cobalt nanoparticles may not be sufficiently formed, and if it exceeds 250° C., the nanoparticles may be sintered. If the hydrothermal synthesis time is less than 3 hours, it may not be synthesized in a hexahedral shape, and if it exceeds 8 hours, the nanoparticles may be sintered.

Thereafter, in one form, the reaction solution including the prepared cobalt nanoparticles may be mixed with distilled water and centrifugation is performed to recover the prepared cobalt nanoparticles, and washing may be performed sufficiently with distilled water.

In another form, the washed cobalt nanoparticles may be dried.

For example, drying may be performed at a temperature in a range of 40° C. to 120° C. for 12 hours to 72 hours. If the drying temperature is less than 40° C., moisture contained in the nanoparticle pores may not be sufficiently dried. If it exceeds 80° C., the nanoparticle structure may collapse. If the drying time is less than 12 hours, moisture in the pores may not be sufficiently dried, and if it exceeds 72 hours, the nanoparticle structure may collapse.

Formation of the shell (Step S2) may be accomplished by: dispersing the prepared cobalt nanoparticle core in a solvent, mixing a cerium precursor and an oxidizing agent in the dispersion, drying, and then firing.

The cerium precursor may include cerium nitrates, cerium hydrochloride, cerium acetates, cerium sulfates, cerium hydroxides, hydrates thereof, or a mixture thereof, for example cerium (III) nitrate (Ce(NO₃)₃), or hydrates thereof.

The solvent may include distilled water, deionized water, ethanol, methanol, ethylene glycol, propylene glycol, isopropyl alcohol, or a mixture thereof. For example, the solvent may include a mixture in a range of 20 volume % to 80 volume % of water and 20 volume % to 80 volume % of ethanol based on the total volume. It is easy to completely disperse the precursor when the solvent includes a mixture of water and ethanol.

The oxidizing agent is diluted in water to form hydroxide ions (OH⁻), and the hydroxide ions react with the cerium precursor to form cerium hydroxide, which can finally form a cerium oxide shell.

The oxidizing agent may include urea, ammonia, sodium carbonate, sodium bicarbonate, potassium carbonate, potassium bicarbonate, sodium acetate, potassium acetate, diethanol amine, trimethylamine, hexamethylene diamine, tetramethylammonium hydroxide, or a mixture thereof.

The oxidizing agent may be dissolved in a solvent and then, added as a solution, wherein a concentration of the oxidizing agent in the solution may be in a range of 0.018 M to 0.15 M. When the concentration of the oxidizing agent in the solution is less than 0.018 M, the cerium hydroxide may not be formed into a core-shell structure. When the concentration is greater than 0.15 M, pH of the solution is changed, destroying the nanoparticle structure.

The oxidizing agent may be included in a range from 0.2 parts by weight to 0.5 parts by weight, for example, 0.2 parts by weight to 0.5 parts by weight based on 100 parts by weight of the cerium precursor. When the oxidizing agent is included in an amount of less than 0.2 parts by weight, the cerium oxide may not be formed into the core-shell structure. When the oxidizing agent is included in an amount of greater than 0.5 parts by weight, the pH of the solution may be changed, destroying the nanoparticle structure.

For example, the mixing may be performed at a temperature in a range of 50° C. to 90° C. for 1 hour to 5 hours at 300 rpm to 1000 rpm. In one embodiment, the cobalt nanoparticles treated with the cerium precursor are centrifuged and recovered and then, sufficiently washed with distilled water and ethanol.

In addition, the cobalt nanoparticles treated with the cerium precursor may be dried.

For example, drying may be performed at a temperature in a range of 40° C. to 120° C. for 12 hours to 72 hours.

Subsequently, the cobalt nanoparticles treated with the cerium precursor are fired, preparing core-shell nanoparticles.

The firing may be performed at a temperature in a range of 300° C. to 900° C. for 2 hours to 12 hours. When the firing is performed at a temperature less than 300° C., the nitrate included in the precursor may not be completely removed. When the firing is performed at a temperature greater than 900° C., the catalyst may be sintered. When the firing time is less than 2 hours, the nitrate included in the precursor may not be completely removed, and when the firing time is greater than 12 hours, the catalyst may be sintered.

In one embodiment, a metal may be supported on the core-shell nanoparticles (Step S3).

As an example, the supporting of the metal (S3) may be supported by dissolving a metal precursor in a solvent, followed by impregnating the core-shell nanoparticles, drying, and then firing.

The metal precursor may include metal nitrates, metal hydrochlorides, metal acetates, metal sulfates, metal hydroxides, hydrates thereof, or a mixture thereof. For example, when the metal is copper (Cu), the metal precursor may be copper (II) nitrate (Cu(NO₃)₂), copper acetate (Cu acetate), or hydrates thereof.

The solvent may include distilled water, deionized water, ethanol, methanol, ethylene glycol, propylene glycol, isopropyl alcohol, or a mixture thereof.

The drying may be performed at a temperature in a range of 60° C. to 150° C. for 12 hours to 72 hours. If the drying temperature is less than 60° C., moisture contained in the nanoparticle pores may not be sufficiently dried, and if the drying temperature exceeds 150° C., active sites may be sintered, and the supported metal precursor may be dissolved. If the drying time is less than 12 hours, moisture in the pores may not be sufficiently dried, and if the drying time exceeds 72 hours, active sites may be sintered.

The firing may be performed at a temperature in a range of 300° C. to 900° C. for 2 hours to 24 hours. When the firing temperature is less than 300° C., the nitrate included in the precursor may not be completely removed. When the firing temperature is greater than 900° C., the catalyst may be sintered. When the firing times is less than 2 hours, the nitrate included in the precursor may not be completely removed, and when the firing times is greater than 24 hours, the supported metal precursor may be dissolved.

In another embodiment, the core-shell nanoparticles may be hydrothermally treated (Step S4).

The hydrothermal treatment may be performed at a temperature in a range of 600° C. to 900° C. for 10 hours to 100 hours. When the hydrothermal treatment is performed at a temperature less than 600° C., it may not meet conditions for a high temperature heat resistance evaluation. When the hydrothermal treatment is performed at a temperature greater than 900° C., the catalyst may be sintered. When the hydrothermal treatment is performed for less than 10 hours, it may not meet conditions for a heat resistance evaluation when driving a vehicle, and when the hydrothermal treatment is performed for greater than 100 hours, the catalyst may be sintered.

In addition, the hydrothermal treatment may be performed under an air atmosphere including 0 volume % to 20 volume % of water (H₂O) and 5 volume % to 20 volume % of oxygen (O₂). When the water (H₂O) is included in an amount of greater than 20 volume % in the hydrothermal treatment, the catalyst may be poisoned. When the oxygen (O₂) is included in an amount of less than 5 volume %, an oxidation reaction may not occur, failing in evaluating activity through catalyst combustion, and when the oxygen (O₂) is included in an amount of greater than 20 volume %, active sites of the catalyst may be sintered.

According to another aspect, an oxidation method of carbon monoxide and hydrocarbon includes reacting carbon monoxide, a hydrocarbon, or a mixture thereof with oxygen in the presence of the aforementioned catalyst to perform oxidation.

As an example, the oxidation method of carbon monoxide and hydrocarbon may be achieved by supplying carbon monoxide, a hydrocarbon, or a mixture thereof and oxygen to a reactor including a catalyst to react them.

The reactor may include a catalyst layer coated on a substrate. The substrate may be any substrate without limitation as long as used for catalyst articles for purifying automobile exhaust gas, for example, a substrate with a metal or ceramic honeycomb structure and also, a monolithic penetrating substrate in which a plurality of fine and parallel gas flow passages run from an inlet of the substrate to an out thereof and are open to a fluid flow.

Since a catalyst material is washcoated with on the walls of the passages of the substate, gas flowing through the passages contacts the catalyst material. The passages of the monolithic substrate are thin-walled channels having any suitable cross-sectional shape such as trapezoidal, rectangular, square, sinusoidal, hexagonal, oval, circular, and the like. Such structures may contain 60 to 1200 or more gas inlet openings (e.g., cells) per one square-inch (cpsi) cross-section area. A representative commercially available substrate is a Corning 400/6 cordierite material composed of cordierite and has a cell density of 400 cpsi and a wall thickness of 6 mm.

The ceramic substrate may be made of any suitable refractory material, for example, cordierite, cordierite-a alumina, silicon nitride, zircon mullite, spodumene, alumina-silica magnesia, zircon silicate, sillimanite, magnesium silicate, zircon, petalite, α alumina, aluminosilicate, etc.

The metal substrate may include another alloy including iron as a substantial or main component as well as heat-resistant metals such as titanium and stainless steel and metal alloys. The alloy may contain one or more metals out of nickel, chromium, and/or aluminum, wherein a total amount of the metals may be 15 wt. % based on a weight of the alloy. For example, the alloy may include 10 wt. % to 25 wt. % of chromium, 3 wt. % to 8 wt. % of aluminum, and a maximum of 20 wt. % of nickel. The alloy may include a small or trace amount of one or more other metals such as manganese, copper, vanadium, titanium, and the like. The metal substrate may have various shapes such as a corrugated plate type, a monolith type, or the like. A representative commercially available metal substrate may be one manufactured by Emitec Inc.

For example, the hydrocarbon may include propene, toluene, ethane, ethene, propane, benzene, xylene, ethylene, 2-methylbutane, formaldehyde, styrene, acetaldehyde, or.

Hereinafter, specific examples of the present disclosure are described. However, the examples described below are for illustrative purposes only, and the scope of the present disclosure is not limited thereto.

### PREPARATION EXAMPLE: PREPARATION OF CORE-SHELL CATALYST

### Example 1

1) Preparation of Cobalt (Co) Cubic Nanoparticles

2.9 g of cobalt (II) nitrate hexahydrate and 0.1 g of sodium hydroxide (NaOH) are added to 10 mL of distilled water and then, sufficiently stirred at room temperature.

A hydrothermal synthesis is performed in a hydrothermal synthesizer at 180° C. for 5 hours.

The reaction solution is mixed with distilled water, and nanoparticles formed therein are recovered through a centrifuge (15000 rpm, 10 minutes) and sufficiently washed with distilled water.

A drying process at 60° C. for 24 hours is performed, obtaining cobalt cubic nanoparticles.

2) Preparation of Co-7.7CeO₂ Core-shell Nanoparticles (Ce/Co Mole Ratio=7.7)

0.05 g of the prepared cobalt cubic nanoparticles are dispersed in a mixed solution of 20 mL of ethanol with high purity and 20 mL of distilled water at room temperature.

Subsequently, 1.04 g to 4.16 g of cerium (III) nitrate hexahydrate and 2.5 mL of a hexamethylenediamine solution at a concentration of 0.022 M are added to the sufficiently dispersed solution and then, stirred at 600 rpm under a nitrogen atmosphere for 2 hours at 70° C.

After the recovery with a centrifuge (15000 rpm, 5 minutes), the recovered products are sufficiently washed by using distilled water and ethanol.

The washed products are dried at 60° C. for 24 hours and fried at 400° C. for 3 hours, preparing Co-7.7CeO₂ core-shell nanoparticles (a Ce/Co mole ratio=7.7).

### Example 2

Co-3.9CeO₂ core-shell nanoparticles (a Ce/Co mole ratio=3.9) are prepared in the same manner as in Example 1, except that the content of the cerium (III) nitrate hexahydrate is adjusted within 1.04 g to 4.16 g.

### Example 3

Co-15.4CeO₂ core-shell nanoparticles (a Ce/Co mole ratio=15.4) are prepared in the same manner as in Example 1, except that the content of the cerium (III) nitrate hexahydrate is adjusted within 1.04 g to 4.16 g.

### Example 4

1 g of the Co-7.7CeO₂ core-shell nanoparticles according to Example 1 and 0.038 g to 0.152 g of copper (II) nitrate trihydrate are supported through an incipient wetness impregnation method.

After supported, the nanoparticles are dried at 90° C. for 24 hours and fired at 400° C. for 5 hours, preparing Cu/Co-7.7CeO₂ (a content of Cu: 1 wt. %).

### Example 5

Cu/Co-7.7CeO₂ (a content of Cu: 2 wt. %) is prepared in the same manner as Example 4, except that the content of the copper (II) nitrate trihydrate is adjusted within 0.038 g to 0.152 g.

### Example 6

Cu/Co-7.7CeO₂ (a content of Cu: 4 wt. %) is prepared in the same manner as Example 4, except that the content of the copper (II) nitrate trihydrate is adjusted within 0.038 g to 0.152 g.

### Comparative Example 1

Copper (II) nitrate trihydrate, cobalt (II) chloride hexahydrate, and cerium (III) nitrate hexahydrate in a mole ratio of 1:5:5 are added to 25 mL of distilled water and then, dissolved therein at room temperature and stirred.

Subsequently, 25 mL of sodium hydroxide (NaOH) at a concentration of 0.375 M is added drop by drop to the solution and then, stirred for 1 hour.

When a reaction is completed, products therefrom are recovered through a centrifuge (6000 rpm, 10 minutes) and then, twice washed with distilled water and ethanol in a ratio of 1:1.

The washed products are dried at 60° C., preparing a Cu—Co—Ce mixed oxide.

### Comparative Example 2

2.9 g of cobalt (II) nitrate hexahydrate and 0.1 g of sodium hydroxide (NaOH) are added to 10 mL of distilled water and dissolved therein at room temperature and then, sufficiently stirred.

A hydrothermal synthesis is performed in a hydrothermal synthesizer at 180°C. for 5 hours.

The reaction solution is mixed with distilled water, and nanoparticles produced therein are recovered through a centrifuge (15000 rpm, 10 minutes) and sufficiently washed with distilled water.

The washed nanoparticles are dried at 60°C. for 24 hours to obtain cobalt cubic nanoparticles, which are used as a catalyst.

### Experimental Example 1: Measurement of Shape of Catalyst

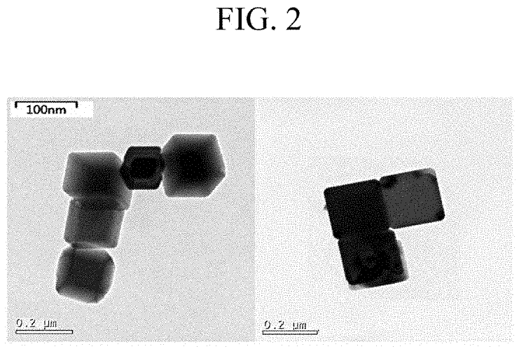

The cobalt nanoparticles according to Example 1 are examined through a transmission electron microscope (TEM), and the result is shown in FIG. 2.

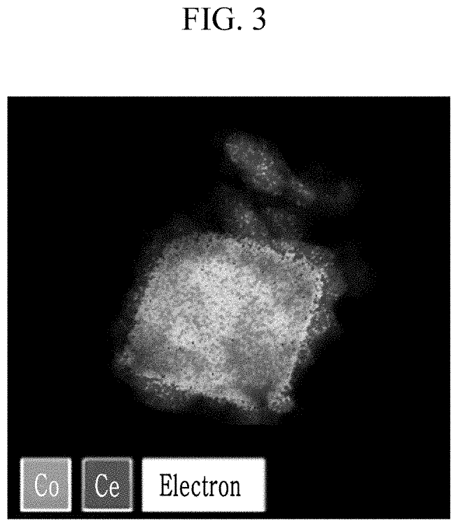

In addition, an element mapping image of the catalyst according to Example 1 is shown in FIG. 3.

Referring to FIG. 2, the cobalt nanoparticles according to Example 1 turn out to have a hexahedral shape. Referring to FIG. 3, the catalyst turns out to have a core-shell nanoparticle shape which includes a cobalt nanoparticle core with a hexahedral shape and a shell surrounding the core and including cerium oxide.

### Experimental Example 2: Measurement of Oxidation Performance of Carbon Monoxide (CO) and Hydrocarbon (HC)

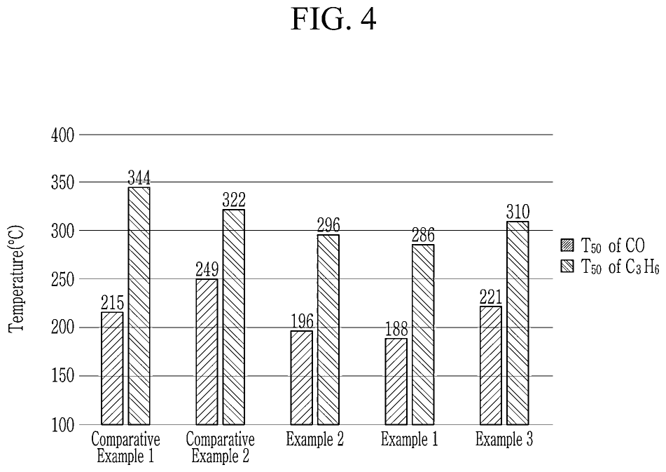

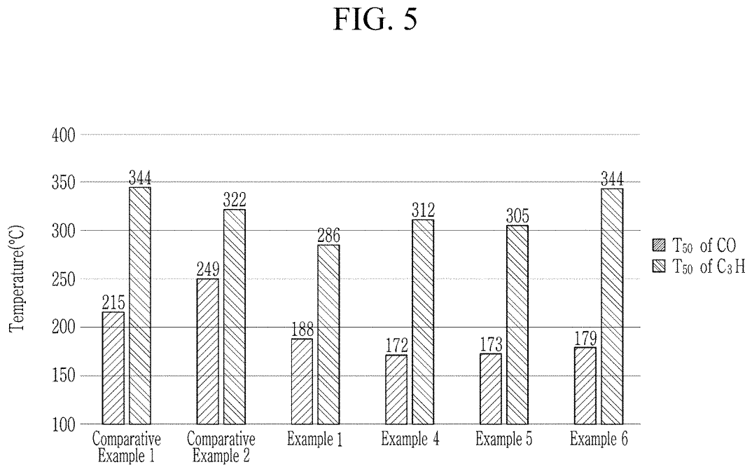

The oxidation performance of carbon monoxide and hydrocarbon of the catalysts prepared in Examples 1 to 6 and Comparative Examples 1 to 2 are measured, and the results are shown in FIGS. 4 and 5.

FIG. 4 is a graph showing the measurement results of oxidation performance of carbon monoxide and hydrocarbon according to the shell content of catalysts prepared in Examples 1 to 3 and Comparative Examples 1 to 2. FIG. 5 is a graph showing the measurement results of oxidation performance of carbon monoxide and hydrocarbon according to the copper content of catalysts prepared in Examples 1 and 4 to 6 and Comparative Examples 1 to 2.

Herein, the catalysts according to Examples 1 to 6 are measured with respect to the oxidation performance after a hydrothermal treatment. The hydrothermal treatment of the catalysts may be performed for 25 hours by flowing air containing 10% of water onto catalyst layers heated to 750° C. at 100 ml/min.

The performance evaluation conditions of catalysts are as follows:
Catalyst amount: 50 mg
Reaction gas: 1000 ppm CO, 300 ppm C₃H₆, 5% H₂O, 10% O₂, balance He
Flow rate: 100 mL/min
Temperature increase condition: from 40° C. to 250° C., temperature rise at 5° C./min
Analyzer: IR.

In FIGS. 4 and 5, T₅₀ of CO represents a temperature at which a content of CO is reduced to 50%, and T₅₀ of C₃H₆ represents a temperature at which a content of C₃H₆ is reduced to 50%.

Referring to FIG. 4, the catalysts including core-shell nanoparticles according to Examples 1 to 3 exhibit excellent oxidation performance of carbon monoxide and hydrocarbon, compared with the Cu—Co—Ce mixed oxide catalyst according to Comparative Example 1 and the cobalt nanoparticles according to Comparative Example 2.

Referring to FIG. 5, the catalysts including core-shell nanoparticles according to Examples 1 and 4 to 6 exhibit excellent oxidation performance of carbon monoxide and hydrocarbon, compared with the Cu—Co—Ce mixed oxide catalyst according to Comparative Example 1 and the cobalt nanoparticles according to Comparative Example 2. In addition, the catalysts including core-shell nanoparticles according to Examples 4 to 6 exhibit much improved oxidation performance of carbon monoxide, compared with the catalysts including core-shell nanoparticles according to Examples 1 to 3.

While the present disclosure has been described in connection with what is presently considered to be practical exemplary embodiments, it should be understood that the present disclosure is not limited to the disclosed embodiments, but, on the contrary, is intended to cover various modifications and equivalent arrangements included within the spirit and scope of the present disclosure.

What is claimed is:

1. A carbon monoxide and hydrocarbon oxidation catalyst, comprising:
a core-shell nanoparticle comprising:
a cobalt (Co) nanoparticle core having a hexahedral shape, and
a shell surrounding the cobalt nanoparticle core,
wherein the shell comprises cerium oxide.

2. The carbon monoxide and hydrocarbon oxidation catalyst of claim 1, wherein the core-shell nanoparticle comprises cobalt (Co) and cerium (Ce) in a mole ratio of greater than 1:0 and less than 1:15.4.

3. The carbon monoxide and hydrocarbon oxidation catalyst of claim 1, further comprising:
a metal supported on the core-shell nanoparticle.

4. The carbon monoxide and hydrocarbon oxidation catalyst of claim 3, wherein the metal comprises copper (Cu), iron (Fe), cobalt (Co), Titanium (Ti), Zinc (Zn), manganese (Mn), nickel (Ni), aluminum (Al), chromium (Cr), tungsten (W), silicon (Si), iridium (Ir), platinum (Pt), rhodium (Rh), palladium (Pd), ruthenium (Ru), Thorium (Th), Vanadium (V), gold (Au), silver (Ag), Rhenium (Re), Zirconium (Zr), molybdenum (Mo), or a mixture thereof.

5. The carbon monoxide and hydrocarbon oxidation catalyst of claim 1, wherein the carbon monoxide and hydrocarbon oxidation catalyst comprises 1 wt. % to 4 wt. % of a metal based on a total weight of the catalyst.

6. A method for preparing a carbon monoxide and hydrocarbon oxidation catalyst, the method comprising:
preparing a cobalt (Co) nanoparticle core having a hexahedral shape;
forming a shell surrounding the cobalt nanoparticle core, wherein the shell comprises cerium oxide; and
preparing a core-shell nanoparticle.

7. The method of claim 6, wherein the cobalt nanoparticle core is prepared by dissolving a cobalt precursor and sodium hydroxide, potassium hydroxide, ammonia, or a mixture thereof in a solvent, followed by a hydrothermal synthesis.

8. The method of claim 7, wherein the sodium hydroxide is mixed in a range from 2 parts by weight to 10 parts by weight based on 100 parts by weight of the cobalt precursor.

9. The method of claim 7, wherein the hydrothermal synthesis is performed at a temperature in a range of 120° C. to 250° C. for 3 hours to 8 hours.

10. The method of claim 6, wherein the forming of the shell comprises:
dispersing the cobalt nanoparticle core in a solvent to obtain a dispersion;
mixing a cerium precursor and an oxidizing agent in the dispersion;
drying the cobalt nanoparticle core; and
firing the cobalt nanoparticle core.

11. The method of claim 10, wherein the solvent comprises 20 volume % to 80 volume % of water and 20 volume % to 80 volume % of ethanol based on a total volume of the solvent.

12. The method of claim 10, wherein the oxidizing agent comprises urea, ammonia, sodium carbonate, sodium bicarbonate, potassium carbonate, potassium bicarbonate, sodium acetate, potassium acetate, diethanol amine, trimethylamine, hexamethylene diamine, tetramethylammonium hydroxide, or a mixture thereof.

13. The method of claim 6, further comprising:
supporting a metal on the core-shell nanoparticle.

14. The method of claim 13, wherein the supporting of the metal comprises:
dissolving a precursor of the metal in a solvent;
impregnating the core-shell nanoparticle;
drying the metal; and
firing the metal.

15. The method of claim 6, wherein the carbon monoxide and hydrocarbon oxidation catalyst is subjected to a hydrothermal treatment.

16. The method of claim 15, wherein the hydrothermal treatment is performed at a temperature in a range of 600° C. to 900° C. for 10 hours to 100 hours.

17. The method of claim 15, wherein the hydrothermal treatment is performed in an air atmosphere comprising 0 volume % to 20 volume % of water (H₂O) and 5 volume % to 20 volume % of oxygen (O₂).

18. An oxidation method of carbon monoxide and hydrocarbon, the method comprising:
reacting carbon monoxide, a hydrocarbon, or a mixture thereof with oxygen in presence of a carbon monoxide and hydrocarbon oxidation catalyst to perform oxidation,
wherein the carbon monoxide and hydrocarbon oxidation catalyst comprises a core-shell nanoparticle comprising:
a cobalt (Co) nanoparticle core having a hexahedral shape, and
a shell surrounding the cobalt nanoparticle core,
wherein the shell comprises cerium oxide.

19. The method of claim 18, wherein the hydrocarbon comprises propene, toluene, ethane, ethene, propane, benzene, xylene, ethylene, 2-methylbutane, formaldehyde, styrene, acetaldehyde, or a mixture thereof.
